(19) United States
(12) Patent Application Publication
(10) Pub. No.: US 2016/0117660 A1
(43) Pub. Date: Apr. 28, 2016

(54) MOBILE WALLET DETECTION AT A CONTACTLESS POINT OF SALE TERMINAL

(71) Applicant: INTEL CORPORATION, Santa Clara, CA (US)

(72) Inventors: Gyan PRAKASH, Beaverton, OR (US); Miguel E. BALLESTEROS, Roseville, CA (US); Phillip J. SITBON, Portland, OR (US)

(21) Appl. No.: 14/129,462

(22) PCT Filed: Jul. 16, 2013
(86) PCT No.: PCT/US2013/050739

§ 371 Date: Dec. 26, 2013

(51) Int. Cl. G06Q 20/20; G06Q 20/32; G06Q 20/36; G06Q 30/02; H04W 4/00

(52) U.S. Cl. CPC G06Q 20/202; G06Q 30/0268; G06Q 30/0267; H04W 4/008; H04W 4/005; G06Q 20/363; G06Q 20/3278

(57) ABSTRACT

Technologies for mobile wallet detection include a mobile communication device implementing a mobile wallet and a point-of-sale terminal. During a transaction, the mobile communication device and the point-of-sale terminal initiate a near-field communication connection, and identification data indicating the type of the mobile wallet is transmitted to the point-of-sale terminal. The identification data may describe the mobile wallet and/or the mobile communication device. The point-of-sale terminal determines the type of the mobile wallet without relying on a third party such as a backend card processor. The point-of-sale terminal identifies offers for services or discounts that may be applied to the purchase transaction based on the type of the mobile wallet. The point-of-sale terminal may transmit the offers to the mobile communication device, which may allow the user to accept the offers. Offers may be determined by querying a third-party offering service. Other embodiments are described and claimed.

### BACKGROUND

Mobile wallet technology allows a portable computing device such as a mobile phone to be used for retail payment transactions. The mobile wallet allows the device to store payment information for several accounts, meaning that a single device may replace several bank or credit cards. Additionally, some devices may allow for “contactless” payments using near-field communication (“NFC”). In such contactless systems, the user may wave or tap the portable device near a designated part of the point-of-sale terminal, and payment information is transferred without requiring a card swipe or other physical contact. Typically, to perform contactless transactions, mobile wallets emulate the interface of a traditional NFC smartcard or other simple payment token. In such systems, the point-of-sale terminal is unable to distinguish between a smartcard and a mobile wallet implemented by a more-capable device.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for mobile wallet detection at a contactless point-of-sale terminal;

FIG. 2 is a simplified block diagram of at least one embodiment of a number of environments that may be established by the system of FIG. 1;

FIG. 3 is a simplified flow diagram of at least one embodiment of a method for mobile wallet detection that may be executed by a mobile communication device of FIGS. 1 and 2; and

FIG. 4 is a simplified flow diagram of at least one embodiment of a method for mobile wallet detection that may be executed by a point-of-sale terminal of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

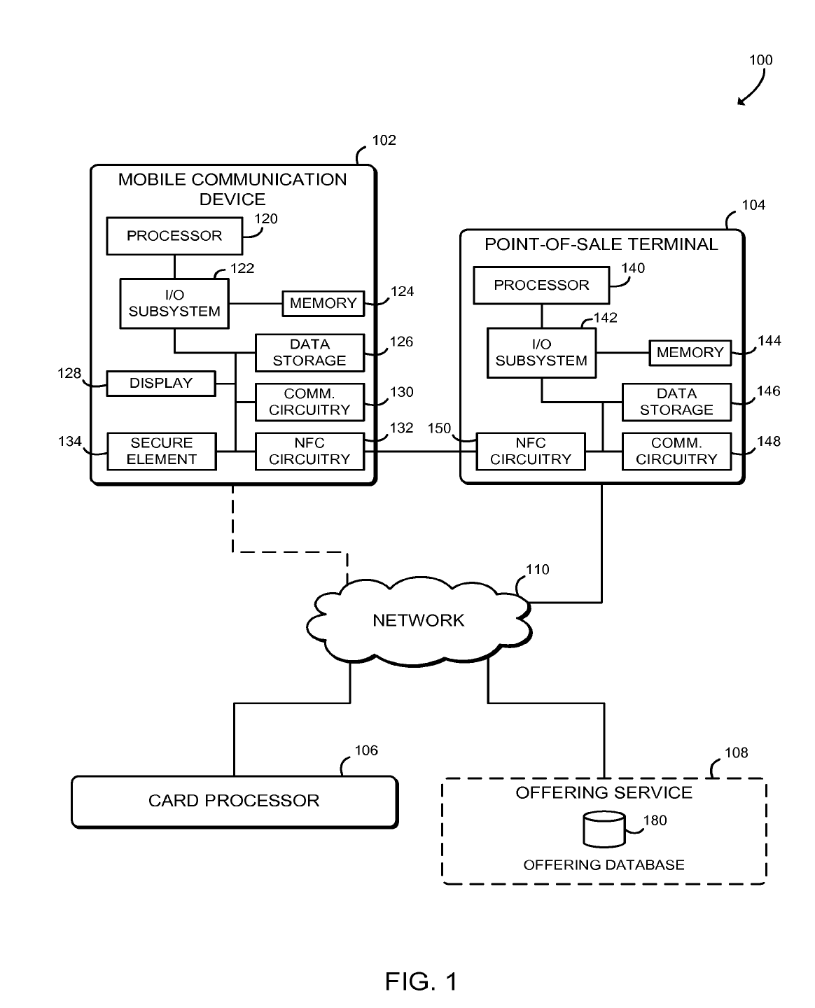

Referring now to FIG. 1, in one embodiment, a system 100 for mobile wallet detection during a transaction includes a mobile communication device 102, a point-of-sale terminal 104, a card processor 106, and in some embodiments an offering service 108, all of which may be in communication with each other over a network 110. In use, as discussed in more detail below, the mobile communication device 102 implements a mobile wallet for completing transactions. When the mobile communication device 102 is presented for payment, the mobile communication device 102 and the point-of-sale terminal 104 establish an NFC connection. Over the NFC connection, the point-of-sale terminal 104 queries the mobile communication device 102 for information identifying the mobile wallet and/or its capabilities. The point-of-sale terminal 104 identifies offers to a user of the mobile wallet based on the type and/or capabilities of the mobile wallet and may present the offers to the user or apply the offers automatically. Any type of offer may be presented to the user including, but not limited to offers for services, discounts, coupons, and/or advertisements, or any other type of offer directed at the user of the mobile wallet. The point-of-sale terminal 104 may query a third-party offering service 108 to identify the offers. After applying any offers, the point-of-sale terminal 104 completes the transaction, for example by submitting payment information received from the mobile communication device 102 to the card processor 106.

The disclosed technologies allow the owner or operator of the point-of-sale terminal 104—typically a retailer—to discern whether the customer is using a standard credit card or a mobile wallet. For example, the disclosed technologies may allow the owner/operator to learn the type and/or capabilities of the mobile wallet application executed on the mobile communication device 102 and/or the mobile computing device 102 itself without relying on a backend service provider such as the card processor 106, the card issuer, or a trusted service manager. With such information, the retailer or other third party may encourage adoption of mobile wallets among its customers, which may provide certain advantages to the retailer or third party because mobile wallets are typically more secure, more flexible, and may have lower processing fees than other payment methods.

The mobile communication device 102 may be embodied as any type of communication device capable of performing the functions described herein. For example, the mobile communication device 102 may be embodied as, without limitation, a smart phone, a feature phone, a cellular telephone, a handset, a messaging device, a computer, a tablet computer, a laptop computer, a notebook computer, a mobile computing device, a work station, a network appliance, a web appliance, a distributed computing system, a multiprocessor system, a processor-based system, a consumer electronic device, a digital television device, and/or any other communication device configured to perform mobile wallet detection with a contactless point-of-sale terminal 104. In the illustrative embodiment of FIG. 1, the mobile communication device 102 includes a processor 120, an input/output subsystem 122, a memory 124, a data storage device 126, a display 128, a communication circuit 130, NFC circuitry 132, and a secure element 134. Of course, the mobile communication device 102 may include other or additional components, such as those commonly found in a smartphone and/or computer (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor capable of performing the functions described herein. For example, the processor 120 may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the mobile communication device 102 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the mobile communication device 102. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the mobile communication device 102, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. The display 128 of the mobile communication device 102 may be embodied as any type of display capable of displaying digital information such as a liquid crystal display (LCD), a light emitting diode (LED), a plasma display, a cathode ray tube (CRT), or other type of display device.

The communication circuit 130 of the mobile communication device 102 may be embodied as any communication circuit, device, or collection thereof, capable of enabling communications between the mobile communication device 102, the point-of-sale terminal 104, the offering service 108, and/or other remote devices. The communication circuit 130 may be configured to use any one or more communication technology (e.g., wireless or wired communications) and associated protocols (e.g., Wideband Code Division Multiple Access (W-CDMA), Global System for Mobile Communications (GSM), Bluetooth®, Wi-Fi®, WiMAX, Ethernet, etc.) to effect such communication.

The NFC circuitry 132 allows for short-ranged radio communication with another device equipped with complementary NFC circuitry. The NFC circuitry 132 may be embodied as relatively short-ranged, high-frequency wireless communication circuitry. The NFC circuitry 132 may implement standards such as ECMA-340/ISO/IEC 18092 and/or ECMA-352/ISO/IEC 21481 to communicate with corresponding NFC circuitry of another device. The NFC circuitry 132 may allow for communication ranges on the order of a few centimeters, as when the mobile communication device 102 is tapped or waved near a corresponding part of the point-of-sale terminal 104. In some embodiments, the NFC circuitry 132 may be integrated with or otherwise form a part of the communication circuit 130.

The secure element 134 may be embodied as any type of circuit, or portion of circuit, that provides secure storage of information and/or a secure execution environment on the mobile communication device 102. Information and processes within the secure element 134 are generally inaccessible to the operating system and any user-level processes of the mobile communication device 102. In some embodiments, the secure element 134 may also be resistant to physical tampering. The secure element 134 may be embodied as a secure microcontroller embedded within the mobile communication device 102. Alternatively or additionally, in some embodiments, the secure element 134 may be embedded within a removable card such as a Universal Integrated Circuit Card (UICC) or a removable memory card. In such embodiments, the secure element 134 may implement a standard such as the GlobalPlatform™ Card Specification. In other embodiments, the secure element 134 may be embodied as a trusted platform module (TPM), a security co-processor, a manageability engine, or any other element providing a secure execution or storage environment. In such embodiments, the secure element 134 may be embodied as a separate integrated circuit chip within the mobile communication device 102 or as a portion of another component of the mobile communication device 102, such as the I/O subsystem 122.

The point-of-sale terminal 104 is configured to query the mobile communication device 102 for information on the identity or capabilities of the mobile wallet application and/or the mobile communication device 102 during a contactless transaction. The point-of-sale terminal 104 may be embodied as any type of computing device capable of performing the functions described herein, including, without limitation, a cash register, an electronic kiosk, a computer, a smartphone, a tablet computer, a laptop computer, a notebook computer, a vehicle telematics device, a network appliance, a web appliance, a distributed computing system, a multiprocessor system, a processor-based system, and/or a consumer electronic device. Illustratively, the point-of-sale terminal 104 includes a processor 140, an I/O subsystem 142, a memory 144, a data storage 146, a communication circuit 148, NFC circuitry 150, and/or other components and devices commonly found in a cash register or similar computing device. Those individual components of the point-of-sale terminal 104 may be similar to the corresponding components of the mobile communication device 102, the description of which is applicable to the corresponding components of the point-of-sale terminal 104 and is not repeated herein so as not to obscure the present disclosure.

The card processor 106 is configured to process payment information submitted by the point-of-sale terminal 104. As such, the card processor 106 may include components and features similar to the mobile communication device 102 and/or the point-of-sale terminal 104, such as a processor, I/O subsystem, memory, data storage, communication circuitry, and various peripheral devices, which are not illustrated in FIG. 1 for clarity of the present description. The card processor 106 may be controlled or operated by a third party, different from the user of a mobile communication device 102 or the operator of the point-of-sale terminal 104, such as a card issuer, bank, or trusted service manager. Further, although the illustrative system 100 of FIG. 1 includes one card processor 106, it should be understood that any number of card processors 106 may interact with the system 100.

In some embodiments, the offering service 108 is configured to provide offering information stored in the offering database 180 to the point-of-sale terminal 104, based on the identity and/or capabilities of the mobile wallet application and/or the mobile communication device 102. Similar to the card processor 106, the offering service 108 may include components and features similar to the mobile communication device 102 and/or the point-of-sale terminal 104, such as a processor, I/O subsystem, memory, data storage, communication circuitry, and various peripheral devices, which are not illustrated in FIG. 1 for clarity of the present description.

As discussed in more detail below, the mobile communication device 102, the point-of-sale terminal 104, the card processor 106, and the offering service 108 may be configured to transmit and receive data with each other and/or other devices of the system 100 over the network 110. The network 110 may be embodied as any number of various wired and/or wireless networks. For example, the network 110 may be embodied as, or otherwise include, a wired or wireless local area network (LAN), a wired or wireless wide area network (WAN), and/or a publicly-accessible, global network such as the Internet. As such, the network 110 may include any number of additional devices, such as additional computers, routers, and switches, to facilitate communications among the devices of the system 100.

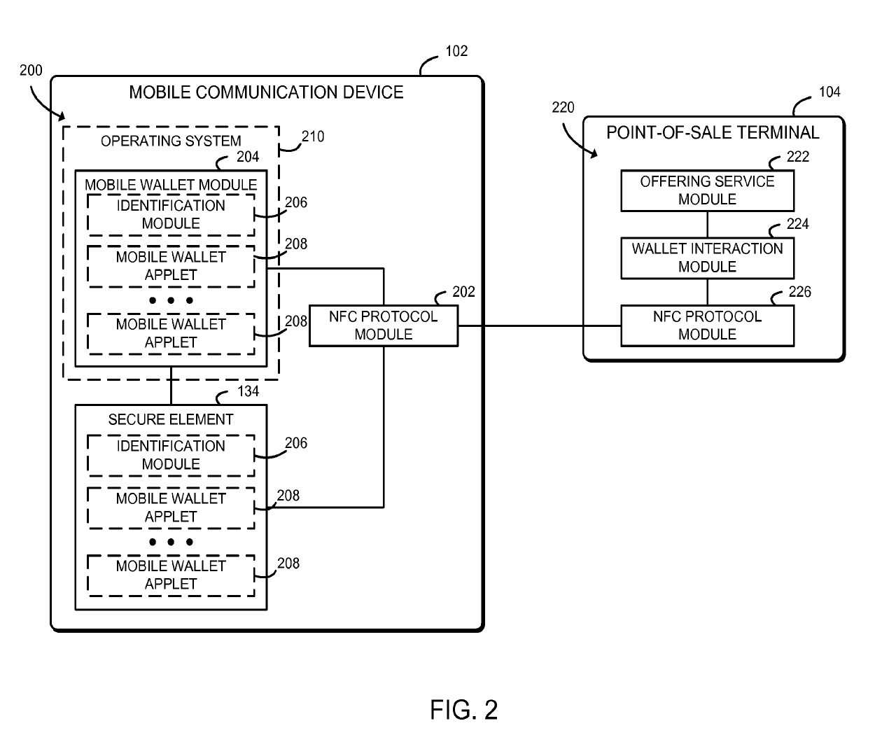

Referring now to FIG. 2, in the illustrative embodiment, the mobile communication device 102 establishes an environment 200 during operation. The illustrative environment 200 includes an NFC protocol module 202 and a mobile wallet module 204. The various modules of the environment 200 may be embodied as hardware, firmware, software, or a combination thereof.

The NFC protocol module 202 is configured to initiate an NFC connection with the point-of-sale terminal 104. The NFC connection may be used to transmit and receive identification data and/or offer information. As described below, the NFC protocol module 202 may establish a connection using any NFC mode supported by the point-of-sale terminal 104, including reader/writer mode, peer-to-peer mode, or card emulation mode.

The mobile wallet module 204 is configured to transmit identification data to the point-of-sale terminal 104 and receive offers in response to the identification data. The mobile wallet module 204 may also allow the user to accept offers and transmit an indication of the user's acceptance to the point-of-sale terminal 104. The mobile wallet module 204 may use services provided by the NFC protocol module 202 to communicate with the point-of-sale terminal 104. As described below, the offers received may include any offer to the user for services or discounts. In some embodiments, the identification data may be stored in an identification module 206. Additionally, the mobile wallet module 204 may store account information relating to the various forms of payment that may be used for transactions. The mobile wallet module 204 may provide a user interface to allow the user to configure forms of payment, select forms of payment, and initiate transactions. In some embodiments, the payment information may be stored in one or more mobile wallet applets 208, which may be selectable and invoked by the mobile wallet module 204 according to a unique identifier such as an application identifier (“AID”).

As illustrated in FIG. 2, in some embodiments the mobile wallet module 204 may be contained in and/or execute within an operating system 210 of the mobile communication device 102. In such embodiments, the mobile wallet module 204 may execute in a user-level mode typical of an ordinary application, or may execute as a privileged operating system process. In either situation, the data stored or transmitted by the mobile wallet module 204, the identification module 206, and/or any mobile wallet applets 208 within the mobile wallet module 204 may be accessible to the operating system 210. Such accessibility may mean that the payment data is only as secure as the operating system 210. The identification module 206 may be embodied as an independent application executing within the operating system 210 or may be otherwise incorporated in the mobile wallet module 204 executing within the operating system 210. In other embodiments, the identification module 206 may be incorporated in one or more of the mobile wallet applets 208 executing within the operating system 210.

In some embodiments, the identification module 206 and/or one or more of the mobile wallet applets 208 may be resident in and/or execute within the secure element 134. Data stored by the identification module 206 and/or the mobile wallet applets 208 within the secure element 134 may be inaccessible or otherwise secured from the operating system 210 and any user-level applications within the operating system 210. Additionally, in some embodiments the secure element 134 may have direct access to the NFC protocol module 202, allowing data to be transmitted without being accessible to the operating system 210 or its applications. As described above, the identification module 206 may be embodied as an independent application or applet embedded within the secure element 134, for example implemented according to the Java Card™ specification. In other embodiments, the identification module 206 may be incorporated in one or more of the mobile wallet applets 208 embedded within the secure element 134. Accordingly, storing identification data in the secure element 134 may be more resistant to tampering but more complicated to implement compared to storing identification data within the operating system 210, and vice versa. Of course, in some embodiments, the mobile communication device 102 may include an identification module 206 and/or mobile wallet applets 208 that are stored or executed within both the mobile wallet module 204 and the secure element 134.

Still referring to FIG. 2, in the illustrative embodiment, the point-of-sale terminal 104 establishes an environment 220 during operation. The illustrative environment 220 includes an offering service module 222, a wallet interaction module 224, and an NFC protocol module 226. The various modules of the environment 220 may be embodied as hardware, firmware, software, or a combination thereof.

The NFC protocol module 226 is configured to initiate an NFC connection with the mobile communication device 102 (or vice-versa). As described above, the NFC connection may be used to transmit and receive identification data and/or offer information. As described below, the NFC protocol module 226 may establish a connection using any NFC mode supported by the mobile communication device 102, including reader/writer mode, peer-to-peer mode, or card emulation mode.

The wallet interaction module 224 is configured to receive identification data from the mobile communication device 102. Additionally, the wallet interaction module 224 receives payment information from the mobile communication device 102 and may submit the payment information to the card processor 106 to complete the payment transaction. The wallet interaction module 224 may use services provided by the NFC protocol module 226 to communicate with the mobile communication device 102.

The offering service module 222 is configured to identify offers based on the identification data received by the wallet interaction module 224. Additionally, the offers may be identified based on the current transaction, for example based on particular items being purchased, the customer's purchase history, current promotions, the date, and/or other criteria. In some embodiments, the offering service module 222 may query the offering service 108 for appropriate offers. As described below, the offers may provide services and/or discounts to the user of the mobile communication device 102. Some offers may be applied automatically by the point-of-sale terminal 104; other offers require the user of the mobile communication device 102 to accept before the offer may be applied. In some embodiments, the offering service module 222 may transmit the offers the mobile communication device 102 and receive any indication of the user's acceptance.

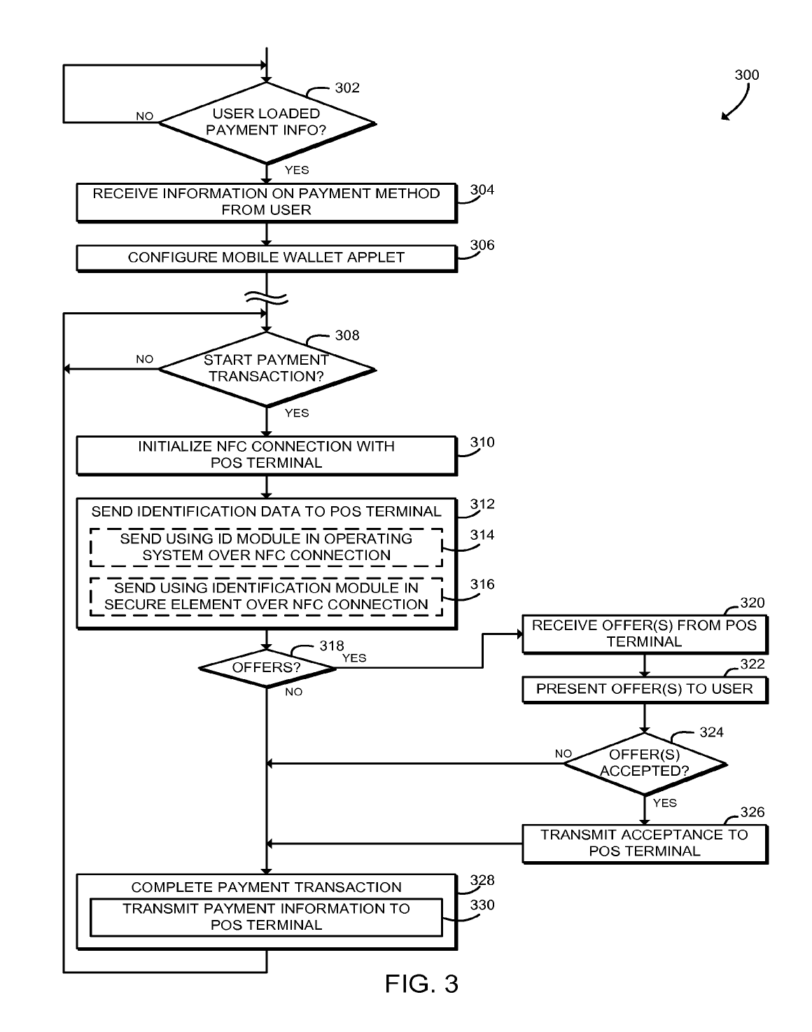

Referring now to FIG. 3, in use, the mobile communication device 102 may execute a method 300 for mobile wallet detection during a contactless transaction. The method 300 begins with block 302, in which the mobile communication device 102 determines whether the user has loaded a form of payment (e.g., a credit card or account information). The user may load a form of payment through a user interface of the mobile communication device 102. If no form of payment is loaded, the method 300 loops back to block 302 to continue waiting for a form of payment. If the user has selected a form of payment, the method 300 advances to block 304.

In block 304, the mobile communication device 102 receives information on the payment method from the user. The information may include account information, card or account type, and/or any other information required for payment processing. The mobile communication device 102 may receive payment information for several different accounts or methods of payments.

In block 306, the mobile communication device 102 configures a mobile wallet applet 208 with the payment information received from the user. After being configured, the mobile wallet applet 208 may be used to complete a transaction. In some embodiments, after configuration the mobile wallet applet 208 may be accessible and/or resident within the operating system 210 of the mobile communication device 102. Additionally or alternatively, the mobile wallet applet 208 may be embedded within the secure element 134. When the mobile wallet applet 208 is embedded within the secure element 134, account information or other sensitive payment information may be inaccessible to the operating system 210 and user-level applications of the mobile communication device 102.

After some time, in block 308, the mobile communication device 102 determines whether a transaction should be started. In some embodiments, the mobile communication device 102 may start a transaction in response to detecting a signal from the point-of-sale terminal 104. For example, the mobile communication device 102 may start a transaction when the NFC circuitry 132 of the mobile communication device 102 is energized in response to being placed near the point-of-sale terminal 104. In other embodiments, the mobile communication device 102 may start a transaction in response to a request from the user through a user interface. For example, the user may select a method of payment using a mobile wallet application of the mobile communication device 102. If no transaction should be started, the method 300 loops back to block 308 to continue monitoring for transactions. If a transaction should be started, the method 300 advances to block 310.

In block 310, the mobile communication device 102 establishes an NFC connection with the point-of-sale terminal 104. After the NFC connection is established, data may be transmitted between the mobile communication device 102 and the point-of-sale terminal 104. The connection may be made using any NFC connection mode supported by both the mobile communication device 102 and the point-of-sale terminal 104. For example, the connection may be made in a read/write NFC communication mode, a peer-to-peer NFC mode, or a card emulation NFC mode. In some embodiments, the mobile communication device 102 may supply the identification data to the point-of-sale terminal 104 by behaving similarly to a passive NFC tag. Additionally or alternatively, in some embodiments, the mobile communication device 102 may emulate an NFC smart card, and the point-of-sale terminal 104 may act as the card reader.

In block 312, the mobile communication device 102 sends identification data identifying the mobile wallet application and/or the mobile communication device 102 to the point-of-sale terminal 104. In some embodiments, the identification data may identify the type of the mobile wallet application or payment capabilities of the mobile wallet application. For example, the identification data may indicate that a mobile wallet is being used (i.e., the mobile communication device 102 is not a traditional smart card or similar payment token). As another example, the identification data may identify the type of mobile wallet by identifying the entity or organization servicing and/or issuing and/or servicing the mobile wallet. Identification data may further identify the forms of payment available through the mobile wallet application.

In some embodiments, the identification data may further indicate the device class of the mobile communication device 102 (e.g., smartphone, feature phone, tablet computer, etc.) and thus may broadly define the basic features of the mobile communication device 102. Additionally or alternatively, the mobile communication device 102 may send identification data indicating one or more capabilities of the mobile communication device 102. For example, the identification data may describe computing resources of the mobile communication device 102, such as processor, available memory, or storage space. As another example, the identification data may describe media playback capabilities of the mobile communication device 102 such as video or audio capability, valid media formats, or screen size. As still another example, the identification data may describe communication capabilities of the mobile communication device 102 such as availability, connection speed, or data plan transfer limits.

In block 314, in some embodiments the mobile communication device 102 may send the identification data over the NFC connection using an identification module 206 resident or visible to the operating system 210. Such identification module 206 may have full access to the mobile communication device 102 and its features. Such operating system 210 application may communicate over the NFC connection in the reader/writer mode and/or the peer-to-peer mode by sending data in response to receiving a query from the point-of-sale terminal 104. Additionally or alternatively, in block 316, in some embodiments the mobile communication device 102 may send the identification data over the NFC connection using an identification module 206 embedded in the secure element 134. Because the secure element 134 may have direct access to the NFC circuitry 132, data sent by such secure applets may be fully isolated from any other applications and/or operating system 210 of the mobile communication device 102. Such secure applets may send the identification data over the NFC connection in the card emulation NFC mode, by sending response application protocol data units in response to command application protocol data units received from the point-of-sale terminal 104. As described above, the placement of the identification module 206 within the operating system 210 or within the secure element 134 involves a trade-off between security and tamper-resistance against complexity.

In block 318, the mobile communication device 102 determines whether the point-of-sale terminal 104 has identified offers based on the identification data. The mobile communication device 102 may query the point-of-sale terminal 104, or the point-of-sale terminal 104 may send data to the mobile communication device 102 indicating that offers have been identified. Note that in some embodiments, the point-of-sale terminal 104 may process offers itself without transmitting any offers to the mobile communication device 102, as described below. If no offers have been identified, the method 300 branches ahead to block 328 to complete the transaction as described below. If any offers have been identified, the method 300 advances to block 320.

In block 320, the mobile communication device 102 receives one or more offers from the point-of-sale terminal 104. The received offers may provide for additional services or discounts and may apply to the current transaction or to another transaction. As described further below, the point-of-sale terminal 104 identifies the offers based on the identification data. The offers may have been received from the third-party offering service 108.

In block 322, the mobile communication device 102 presents the received offers to the user. The mobile communication device 102 may display the offers to the user, for example by displaying a textual description of the offer, displaying a graphical representation of a coupon, displaying an advertisement, or adjusting the price of the current payment transaction. In some embodiments, the mobile communication device 102 may allow the user to accept or decline the offer, for example by presenting appropriate options in a user interface.

In block 324, the mobile communication device 102 determines whether the user has accepted the offers. As described above, the user may accept an offer by selecting an appropriate option in a user interface of the mobile communication device 102. For offers that may not be accepted by the user, for example discounts automatically applied, the mobile communication device 102 may determine that the offer has not been accepted. If the offers are not accepted, the method 300 branches to block 328 to complete the transaction, as described below. If the offer is accepted, the method 300 advances to block 326.

In block 326, the mobile communication device 102 transmits a message to the point-of-sale terminal 104 indicating the user's acceptance of one or more offers. In response to transmitting the acceptance, the point-of-sale terminal 104 may apply the offer to the purchase transaction, activate an offered service, or perform another activity appropriate for the accepted offer. After transmitting the indication of acceptance, the method 300 branches to block 328 to complete the transaction.

In block 328, the mobile communication device 102 completes the transaction. As part of completing the transaction, in block 330, the mobile communication device 102 transmits payment information to the point-of-sale terminal 104. Payment information may include account information, authorization information, and/or any other data required to complete the payment transaction. The mobile communication device 102 may select payment information interactively, for example by receiving a selection of a method of payment through a user interface, or non-interactively, for example by selecting a most-recently-used method of payment or by employing another appropriate heuristic. As described above, after being selected, the payment information may be transmitted to the point-of-sale terminal 104 by a mobile wallet applet 208 resident in or visible to the operating system 210, or by a mobile wallet applet 208 embedded in the secure element 134 of the mobile communication device 102. Additionally, to complete the transaction the mobile communication device 102 may receive additional messages from the point-of-sale terminal 104 indicating whether the payment was accepted or declined, or any other messages indicating the status of the payment transaction. After completing the payment transaction, the method 300 loops back to block 306 to perform additional transactions.

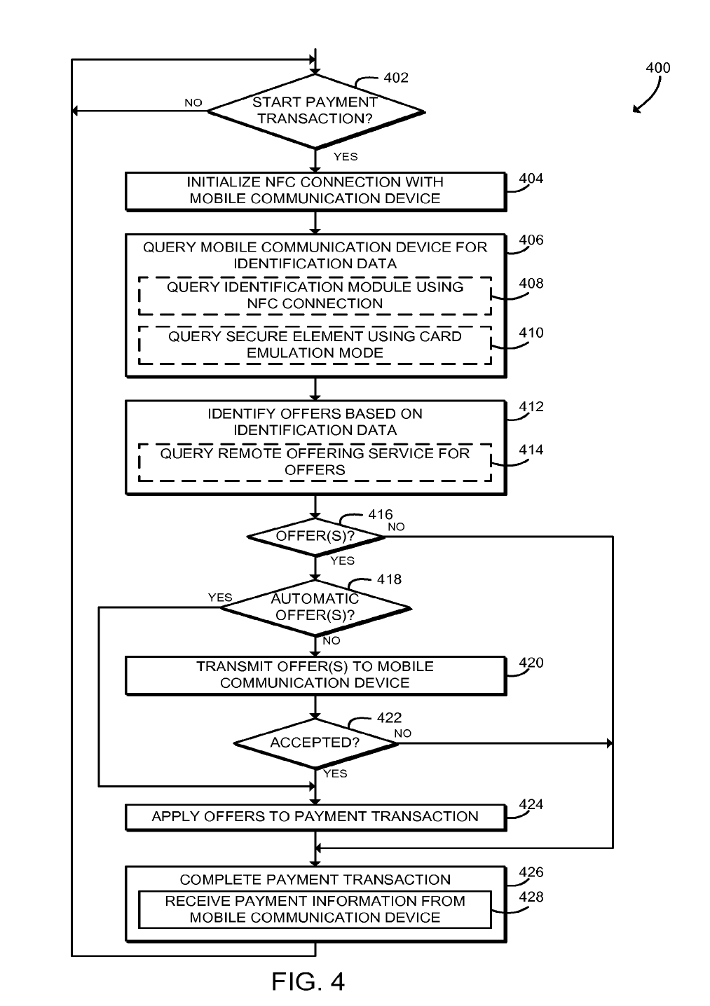

Referring now to FIG. 4, in use, the point-of-sale terminal 104 may execute a method 400 for mobile wallet detection during a contactless transaction. The method 400 begins with block 402, in which the point-of-sale terminal 104 determines whether to start a transaction. In some embodiments, the point-of-sale terminal 104 may start a transaction in response to input received from a user; for example, a user may select an item for purchase on the point-of-sale terminal 104. Additionally or alternatively, in some embodiments the point-of-sale terminal 104 may start a transaction in response to detecting a signal from the mobile communication device 102. For example, the NFC circuitry 150 of the point-of-sale terminal 104 may detect a signal from the mobile communication device 102 when that device is placed near the point-of-sale terminal 104. If the point-of-sale terminal 104 determines not to start a transaction, the method 400 loops back to block 402 to continue monitoring for transactions. If the point-of-sale terminal 104 determines to start a transaction, the method 400 advances to block 404.

In block 404, the point-of-sale terminal 104 initializes an NFC connection with the mobile communication device 102. After the NFC connection is established, data may be transmitted between the point-of-sale terminal 104 and the mobile communication device 102. The connection may be made using any NFC connection mode supported by both the mobile communication device 102 and the point-of-sale terminal 104. As described above, the connection may be made in a read/write NFC communication mode, a peer-to-peer NFC mode, or a card emulation NFC mode. In some embodiments, the point-of-sale terminal 104 may read data from the mobile communication device 102 similarly to reading data from a passive NFC tag. In some embodiments, the point-of-sale terminal 104 may act as a card reader, and the mobile communication device 102 may emulate an NFC smart card.

In block 406, the point-of-sale terminal 104 queries the mobile communication device 102 for its identification data. The point-of-sale terminal 104 receives identification data indicating the type of the mobile communication device 102. As described above, the identification data may describe, without limitation, the type of the mobile wallet application, the issuing or servicing entity of the mobile wallet, the payment capabilities of the mobile wallet application, the device class of the mobile communication device 102, computing capabilities of the mobile communication device 102, media playback capabilities of the mobile communication device 102, communication capabilities of the mobile communication device 102, and/or other characteristics of the mobile communication device 102, the mobile wallet module 204, and/or the mobile wallet applet 208.

In block 408, in some embodiments the point-of-sale terminal 104 may query an application resident in or accessible to the operating system 210 of the mobile communication device 102 for identification data using the NFC connection. Such applications may be queried using the NFC connection in the reader/writer mode or the peer-to-peer mode by sending appropriately-formatted data to the mobile communication device 102 and receiving identification data in response. In block 410, in some embodiments, the point-of-sale terminal 104 may query an application embedded in the secure element 134 of the mobile communication device 102 using the card emulation mode. For example, the point-of-sale terminal 104 may send command application protocol data units to the mobile communication device 102 to query the mobile communication device 102 and may receive response application protocol data units including the identification data.

In block 412, the point-of-sale terminal 104 identifies offers based on the identification data provided by the mobile communication device 102. Such offers may provide for additional services or discounts and may apply to the current transaction or to another transaction. In the illustrative embodiment, the offers are based on the identification data; for example, a particular discount may be offered for transactions using any device with mobile wallet capability, i.e., devices more capable than smartcards. Additionally, the offers may be based on other criteria as discussed above including, but not limited to, the purchased product(s)/service(s), customer purchase history, promotions, and/or other criteria. The offers may be determined locally on the point-of-sale terminal 104 without relying on the card processor 106, card issuer, or any other third party. Additionally or alternatively in some embodiments, in block 414 the point-of-sale terminal 104 may query an offering service 108 for offers based on the identification data. As described above, the offering service 108 maintains an offering database 180 including offers available for various transactions. The offering service 108 may be operated by a third party such as a mobile wallet provider, card issuer, card processor, or trusted service manager. In other embodiments, the offering service 108 may be operated by the owner or operator of the point-of-sale terminal 104, such as the retailer.

In block 416, the point-of-sale terminal 104 determines whether offers have been identified. If not, the method 400 branches ahead to block 426 to complete the transaction, as described below. If offers have been identified, the method 400 advances to block 418. In block 418, the point-of-sale terminal 104 determines whether automatic offers have been identified. Automatic offers may be applied by the point-of-sale terminal 104 to the transaction without further interaction by the user of the mobile communication device 102. For example, automatic offers may include automatic discounts applicable to the payment transaction or to particular items of the payment transaction. If automatic offers have been identified, the method 400 branches ahead to block 424 to apply the offers, as described below. If no automatic offers have been identified, the method 400 advances to block 420.

In block 420, the point-of-sale terminal 104 has identified offers that are not automatic; that is, the identified offers require user intervention prior to being applied to the transaction. For example, the offers may include credit arrangements or service offers requiring an agreement from the user of the mobile communication device 102. Accordingly, the point-of-sale terminal 104 transmits such offers to the mobile communication device 102. After transmitting the offers, the point-of-sale terminal 104 awaits a response from the mobile communication device 102 indicating whether or not the offers are accepted. In block 422, the point-of-sale terminal 104 determines whether the offers have been accepted. If not accepted, the method 400 branches ahead to block 426 to complete the transaction. If accepted, the method 400 advances to block 424. Although not illustrated, it should be noted that in some embodiments, offers may be accepted on the point-of-sale terminal 104 without being transmitted to the mobile communication device 102. For example, a user of the point-of-sale terminal 104 (e.g., a retail employee) may obtain oral acceptance of the offer from the user of the mobile communication device 102 and may indicate that acceptance through a user interface of the point-of-sale terminal 104.

In block 424, the point-of-sale terminal 104 applies the identified offers to the transaction. The point-of-sale terminal 104 may adjust displayed price information or otherwise provide feedback to indicate that an offer has been applied. For example, the point-of-sale terminal 104 may apply a discount to the payment transaction or to individual items of the payment transaction. In some embodiments, the point-of-sale terminal 104 may contact another entity to apply the offer. For example, the point-of-sale terminal 104 may contact a service provider to activate an offered service for the user. As described above, offers may be applied after being accepted by the user of the mobile communication device 102, or automatically without user intervention. In some embodiments, the point-of-sale terminal 104 may process each offer individually, allowing both automatic offers and offers requiring user acceptance to be applied to the same transaction.

In block 426, the point-of-sale terminal 104 completes the transaction. As part of completing the transaction, in block 428, the point-of-sale terminal 104 receives payment information from the mobile communication device 102. Payment information may include account information, authorization information, or any other data required to complete the transaction. The point-of-sale terminal 104 may transmit the payment information to an appropriate card processor 106 to complete the purchase transaction. Additionally, the point-of-sale terminal 104 may send messages to the mobile communication device 102 indicating whether the payment was accepted or declined, or any other messages indicating the status of the transaction. After completing the transaction, the method 400 loops back to block 402 to perform additional transactions.

### EXAMPLES

Illustrative examples of the technologies disclosed herein are provided below. An embodiment of the technologies may include any one or more, and any combination of, the examples described below.

Example 1 includes a mobile communication device for contactless transactions, the mobile communication device comprising a near-field communication protocol module to initiate a near-field communication connection with a point-of-sale terminal; an identification module to transmit identification data using the near-field communication connection, the identification data to indicate that the mobile communication device comprises a mobile wallet; and a mobile wallet module to receive, using the near-field communication connection, an offer from the point-of-sale terminal in response to transmission of the identification data, the offer comprising an offer to a user of the mobile communication device based on the identification data.

Example 2 includes the subject matter of Example 1, and wherein the identification data comprises identification data to indicate a type of the mobile wallet of the mobile communication device.

Example 3 includes the subject matter of any of Examples 1 and 2, and wherein the identification data comprises identification data to identify a servicing entity of the mobile wallet module.

Example 4 includes the subject matter of any of Examples 1-3, and wherein the identification data further comprises capability data to describe a capability of the mobile communication device.

Example 5 includes the subject matter of any of Examples 1-4, and wherein the capability of the mobile communication device comprises: a computing capability, a media playback capability, or a data communication capability.

Example 6 includes the subject matter of any of Examples 1-5, and wherein to transmit the identification data comprises to transmit the identification data using a read/write near-field communication mode.

Example 7 includes the subject matter of any of Examples 1-6, and wherein to transmit the identification data comprises to transmit the identification data using a peer-to-peer near-field communication mode.

Example 8 includes the subject matter of any of Examples 1-7, and wherein to transmit the identification data comprises to transmit the identification data using a card emulation near-field communication mode.

Example 9 includes the subject matter of any of Examples 1-8, and further including a secure element, the secure element comprising the identification module, wherein the identification data stored in the secure element is not accessible to an operating system of the mobile communication device.

Example 10 includes the subject matter of any of Examples 1-9, and wherein to transmit the identification data comprises to send a response application protocol data unit in response to receipt of a command application protocol data unit from the point-of-sale terminal.

Example 11 includes the subject matter of any of Examples 1-10, and wherein the secure element comprises: an embedded secure element, a subscriber identity module secure element, or a flash memory card secure element.

Example 12 includes the subject matter of any of Examples 1-11, and wherein the offer comprises an offer to the user for a service or for a discount.

Example 13 includes the subject matter of any of Examples 1-12, and wherein the mobile wallet module is further to present the offer to the user of the mobile communication device.

Example 14 includes the subject matter of any of Examples 1-13, and further including a display, wherein to present the offer comprises to display an advertisement on the display.

Example 15 includes the subject matter of any of Examples 1-14, and wherein the mobile wallet module is further to determine whether the user accepts the offer in response to presentation of the offer to the user; and transmit an indication of the acceptance of the user from the mobile communication device to the point-of-sale terminal in response to a determination that the user accepts the offer.

Example 16 includes a point-of-sale terminal for contactless transactions, the point-of-sale terminal comprising a near-field communication protocol module to initiate a near-field communication connection with a mobile communication device; a wallet interaction module to receive identification data using the near-field communication connection, the identification data to indicate that the mobile communication device comprises a mobile wallet; and an offering service module to identify an offer to a user of the mobile communication device based on the identification data.

Example 17 includes the subject matter of Example 16, and wherein the identification data comprises identification data to indicate a type of the mobile wallet of the mobile communication device.

Example 18 includes the subject matter of any of Examples 16 and 17, and wherein the identification data comprises identification data to identify a servicing entity of the mobile wallet of the mobile communication device.

Example 19 includes the subject matter of any of Examples 16-18, and wherein the identification data further including capability data to describe a capability of the mobile communication device.

Example 20 includes the subject matter of any of Examples 16-19, and wherein the capability of the mobile communication device comprises: a computing capability, a media playback capability, or a data communication capability.

Example 21 includes the subject matter of any of Examples 16-20, and wherein the offer comprises an offer to the user for a service or for a discount.

Example 22 includes the subject matter of any of Examples 16-21, and wherein the offering service module is further to apply the offer to a transaction without intervention of the user of the mobile communication device.

Example 23 includes the subject matter of any of Examples 16-22, and wherein the offering service module is further to transmit the offer from the point-of-sale terminal to the mobile communication device using the near-field communication connection.

Example 24 includes the subject matter of any of Examples 16-23, and wherein the offer comprises an advertisement to be displayed on a display of the mobile communication device.

Example 25 includes the subject matter of any of Examples 16-24, and wherein the offering service module is further to receive, from the mobile communication device, an indication of the acceptance of the user of the mobile communication device in response to transmission of the offer; and apply the offer to a transaction in response to receipt of the acceptance.

Example 26 includes the subject matter of any of Examples 16-25, and wherein to receive the identification data comprises to receive the identification data using a read/write near-field communication mode.

Example 27 includes the subject matter of any of Examples 16-26, and wherein to receive the identification data comprises to receive the identification data using a peer-to-peer near-field communication mode.

Example 28 includes the subject matter of any of Examples 16-27, and wherein to receive the identification data comprises to receive the identification data using a card emulation near-field communication mode.

Example 29 includes the subject matter of any of Examples 16-28, and wherein to receive the identification data comprises to transmit a command application protocol data unit from the point-of-sale terminal to the mobile communication device; and receive a response application protocol data unit from the mobile communication device in response to transmitting the command application protocol data unit.

Example 30 includes the subject matter of any of Examples 16-29, and wherein to identify the offer based on the identification data comprises to determine the offer on the point-of-sale terminal.

Example 31 includes the subject matter of any of Examples 16-30, and wherein to identify the offer based on the identification data comprises to query a remote offering service for the offer based on the identification data.

Example 32 includes the subject matter of any of Examples 16-31, and wherein to identify the offer further comprises to identify the offer based on a current transaction.

Example 33 includes a method for performing a contactless transaction, the method comprising initiating, by a mobile communication device, a near-field communication connection with a point-of-sale terminal; transmitting, from the mobile communication device to the point-of-sale terminal using the near-field communication connection, identification data indicating that the mobile communication device comprises a mobile wallet; and receiving, by the mobile communication device using the near-field communication connection, an offer from the point-of-sale terminal in response to transmitting the identification data, the offer comprising an offer to a user of the mobile communication device based on the identification data.

Example 34 includes the subject matter of Example 33, and wherein transmitting the identification data comprises transmitting identification data indicating a type of the mobile wallet of the mobile computing device.

Example 35 includes the subject matter of any of Examples 33 and 34, and wherein transmitting the identification data comprises transmitting identification data identifying a servicing entity of the mobile wallet.

Example 36 includes the subject matter of any of Examples 33-35, and wherein transmitting the identification data further comprises transmitting capability data describing a capability of the mobile communication device.

Example 37 includes the subject matter of any of Examples 33-36, and wherein transmitting the capability data comprises transmitting capability data describing: a computing capability of the mobile communication device, a media playback capability of the mobile communication device, or a data communication capability of the mobile communication device.

Example 38 includes the subject matter of any of Examples 33-37, and wherein transmitting the identification data comprises transmitting the identification data using a read/write near-field communication mode.

Example 39 includes the subject matter of any of Examples 33-38, and wherein transmitting the identification data comprises transmitting the identification data using a peer-to-peer near-field communication mode.

Example 40 includes the subject matter of any of Examples 33-39, and wherein transmitting the identification data comprises transmitting the identification data using a card emulation near-field communication mode.

Example 41 includes the subject matter of any of Examples 33-40, and wherein transmitting the identification data comprises transmitting the identification data using a secure element of the mobile communication device, wherein the identification data stored in the secure element is not accessible to an operating system of the mobile communication device.

Example 42 includes the subject matter of any of Examples 33-41, and wherein transmitting the identification data using the secure element comprises sending a response application protocol data unit in response to receiving a command application protocol data unit from the point-of-sale terminal.

Example 43 includes the subject matter of any of Examples 33-42, and wherein transmitting the identification data using the secure element comprises transmitting the identification data using: an embedded secure element, a subscriber identity module secure element, or a flash memory card secure element.

Example 44 includes the subject matter of any of Examples 33-43, and wherein receiving the offer comprises receiving an offer to the user for a service or for a discount.

Example 45 includes the subject matter of any of Examples 33-44, and further including presenting the offer to the user of the mobile communication device.

Example 46 includes the subject matter of any of Examples 33-45, and wherein presenting the offer comprises displaying an advertisement on a display of the mobile communication device.

Example 47 includes the subject matter of any of Examples 33-46, and further including determining, by the mobile communication device, whether the user accepts the offer in response to presenting the offer to the user; and transmitting an indication of the acceptance of the user from the mobile communication device to the point-of-sale terminal in response to determining that the user accepts the offer.

Example 48 includes a method for contactless transactions, the method comprising initiating, by a point-of-sale terminal, a near-field communication connection with a mobile communication device; receiving, by the point-of-sale terminal using the near-field communication connection, identification data indicating that the mobile communication device comprises a mobile wallet; and identifying, by the point-of-sale terminal, an offer to a user of the mobile communication device based on the identification data.

Example 49 includes the subject matter of Example 48, and wherein receiving the identification data comprises receiving identification data indicating a type of the mobile wallet of the mobile computing device.

Example 50 includes the subject matter of any of Examples 48 and 49, and wherein receiving the identification data comprises receiving identification data identifying a servicing entity of the mobile wallet of the mobile communication device.

Example 51 includes the subject matter of any of Examples 48-50, and wherein receiving the identification data comprises receiving capability data describing a capability of the mobile communication device.

Example 52 includes the subject matter of any of Examples 48-51, and wherein receiving the capability data comprises receiving capability data describing: a computing capability of the mobile communication device, a media playback capability of the mobile communication device, or a data communication capability of the mobile communication device.

Example 53 includes the subject matter of any of Examples 48-52, and wherein identifying the offer comprises identifying an offer to the user for a service or for a discount.

Example 54 includes the subject matter of any of Examples 48-53, and further including applying, by the point-of-sale terminal, the offer to a transaction without intervention of the user of the mobile communication device.

Example 55 includes the subject matter of any of Examples 48-54, and further including transmitting the offer from the point-of-sale terminal to the mobile communication device using the near-field communication connection.

Example 56 includes the subject matter of any of Examples 48-55, and wherein transmitting the offer comprises transmitting an advertisement to be displayed on a display of the mobile communication device.

Example 57 includes the subject matter of any of Examples 48-56, and further including receiving, by the point-of-sale terminal from the mobile communication device, an indication of the acceptance of the user of the mobile communication device in response to transmitting the offer; and applying the offer to a transaction in response to receiving the acceptance.

Example 58 includes the subject matter of any of Examples 48-57, and wherein receiving the identification data comprises receiving the identification data using a read/write near-field communication mode.

Example 59 includes the subject matter of any of Examples 48-58, and wherein receiving the identification data comprises receiving the identification data using a peer-to-peer near-field communication mode.

Example 60 includes the subject matter of any of Examples 48-59, and wherein receiving the identification data comprises receiving the identification data using a card emulation near-field communication mode.

Example 61 includes the subject matter of any of Examples 48-60, and wherein receiving the identification data comprises transmitting a command application protocol data unit from the point-of-sale terminal to the mobile communication device; and receiving a response application protocol data unit from the mobile communication device in response to transmitting the command application protocol data unit.

Example 62 includes the subject matter of any of Examples 48-61, and wherein identifying the offer based on the identification data comprises determining the offer by the point-of-sale terminal.

Example 63 includes the subject matter of any of Examples 48-62, and wherein identifying the offer based on the identification data comprises querying a remote offering service for the offer based on the identification data.

Example 64 includes the subject matter of any of Examples 48-63, and wherein identifying the offer further comprises identifying the offer based on a current transaction.

Example 65 includes a computing device comprising a processor; and a memory having stored therein a plurality of instructions that when executed by the processor cause the computing device to perform the method of any of Examples 33-64.

Example 66 includes one or more machine-readable storage media comprising a plurality of instructions stored thereon that in response to being executed result in a computing device performing the method of any of Examples 33-64.

Example 67 includes a computing device comprising means for performing the method of any of Examples 33-64.

1-25. (canceled)

26. A mobile communication device for contactless transactions, the mobile communication device comprising:
a near-field communication protocol module to initiate a near-field communication connection with a point-of-sale terminal;
an identification module to transmit identification data using the near-field communication connection, the identification data to indicate that the mobile communication device comprises a mobile wallet; and
a mobile wallet module to receive, using the near-field communication connection, an offer from the point-of-sale terminal in response to transmission of the identification data, the offer comprising an offer to a user of the mobile communication device based on the identification data.

27. The mobile communication device of claim 26, wherein the identification data further comprises capability data to describe a capability of the mobile communication device.

28. The mobile communication device of claim 26, wherein to transmit the identification data comprises to transmit the identification data using: (i) a read/write near-field communication mode or (ii) a peer-to-peer near-field communication mode.

29. The mobile communication device of claim 26, wherein to transmit the identification data comprises to transmit the identification data using a card emulation near-field communication mode.

30. The mobile communication device of claim 29, further comprising a secure element, the secure element comprising the identification module, wherein the identification data stored in the secure element is not accessible to an operating system of the mobile communication device.

31. The mobile communication device of claim 26, wherein the mobile wallet module is further to present the offer to the user of the mobile communication device.

32. The mobile communication device of claim 31, wherein the mobile wallet module is further to:
determine whether the user accepts the offer in response to presentation of the offer to the user; and
transmit an indication of the acceptance of the user from the mobile communication device to the point-of-sale terminal in response to a determination that the user accepts the offer.

33. A point-of-sale terminal for contactless transactions, the point-of-sale terminal comprising:
a near-field communication protocol module to initiate a near-field communication connection with a mobile communication device;
a wallet interaction module to receive identification data using the near-field communication connection, the identification data to indicate that the mobile communication device comprises a mobile wallet; and
an offering service module to identify an offer to a user of the mobile communication device based on the identification data.

34. The point-of-sale terminal of claim 33, wherein the identification data further comprises capability data to describe a capability of the mobile communication device.

35. The point-of-sale terminal of claim 33, wherein the offering service module is further to apply the offer to a transaction without intervention of the user of the mobile communication device.

36. The point-of-sale terminal of claim 33, wherein the offering service module is further to transmit the offer from the point-of-sale terminal to the mobile communication device using the near-field communication connection.

37. The point-of-sale terminal of claim 36, wherein the offering service module is further to:
receive, from the mobile communication device, an indication of the acceptance of the user of the mobile communication device in response to transmission of the offer; and
apply the offer to a transaction in response to receipt of the acceptance.

38. The point-of-sale terminal of claim 33, wherein to receive the identification data comprises to receive the identification data using a read/write near-field communication mode.

39. The point-of-sale terminal of claim 33, wherein to receive the identification data comprises to receive the identification data using a peer-to-peer near-field communication mode.

40. The point-of-sale terminal of claim 33, wherein to receive the identification data comprises to receive the identification data using a card emulation near-field communication mode.

41. The point-of-sale terminal of claim 33, wherein to identify the offer based on the identification data comprises to query a remote offering service for the offer based on the identification data.

42. One or more computer-readable storage media comprising a plurality of instructions that in response to being executed cause a mobile computing device to:
initiate a near-field communication connection with a point-of-sale terminal;
transmit, from the mobile communication device to the point-of-sale terminal using the near-field communication connection, identification data that indicates that the mobile communication device comprises a mobile wallet; and
receive, using the near-field communication connection, an offer from the point-of-sale terminal in response to transmitting the identification data, the offer comprising an offer to a user of the mobile communication device based on the identification data.

43. The one or more computer-readable storage media of claim 42, wherein to transmit the identification data further comprises to transmit capability data describing a capability of the mobile communication device.

44. The one or more computer-readable storage media of claim 42, further comprising a plurality of instructions that in response to being executed cause the mobile computing device to present the offer to the user of the mobile communication device.

45. The one or more computer-readable storage media of claim 44, further comprising a plurality of instructions that in response to being executed cause the mobile computing device to:
determine whether the user accepts the offer in response to presenting the offer to the user; and
transmit an indication of the acceptance of the user from the mobile communication device to the point-of-sale terminal in response to determining that the user accepts the offer.

46. One or more computer-readable storage media comprising a plurality of instructions that in response to being executed cause a point-of-sale terminal to:
initiate a near-field communication connection with a mobile communication device;
receive, using the near-field communication connection, identification data that indicates that the mobile communication device comprises a mobile wallet; and
identify an offer to a user of the mobile communication device based on the identification data.

47. The one or more computer-readable storage media of claim 46, further comprising a plurality of instructions that in response to being executed cause the point-of-sale terminal to apply the offer to a transaction without intervention of the user of the mobile communication device.

48. The one or more computer-readable storage media of claim 46, further comprising a plurality of instructions that in response to being executed cause the point-of-sale terminal to transmit the offer from the point-of-sale terminal to the mobile communication device using the near-field communication connection.

49. The one or more computer-readable storage media of claim 48, further comprising a plurality of instructions that in response to being executed cause the point-of-sale terminal to:
receive, from the mobile communication device, an indication of the acceptance of the user of the mobile communication device in response to transmitting the offer; and
apply the offer to a transaction in response to receiving the acceptance.

50. The one or more computer-readable storage media of claim 46, wherein to identify the offer based on the identification data comprises to query a remote offering service for the offer based on the identification data.

51. A method for performing a contactless transaction, the method comprising:
initiating, by a mobile communication device, a near-field communication connection with a point-of-sale terminal;
transmitting, from the mobile communication device to the point-of-sale terminal using the near-field communication connection, identification data indicating that the mobile communication device comprises a mobile wallet; and
receiving, by the mobile communication device using the near-field communication connection, an offer from the point-of-sale terminal in response to transmitting the identification data, the offer comprising an offer to a user of the mobile communication device based on the identification data.

52. The method of claim 51, wherein transmitting the identification data comprises transmitting the identification data using a secure element of the mobile communication device, wherein the identification data stored in the secure element is not accessible to an operating system of the mobile communication device.

53. A method for contactless transactions, the method comprising:
initiating, by a point-of-sale terminal, a near-field communication connection with a mobile communication device;
receiving, by the point-of-sale terminal using the near-field communication connection, identification data indicating that the mobile communication device comprises a mobile wallet; and
identifying, by the point-of-sale terminal, an offer to a user of the mobile communication device based on the identification data.

54. The method of claim 53, wherein identifying the offer based on the identification data comprises querying a remote offering service for the offer based on the identification data.
